(19) United States
(12) Patent Application Publication
(10) Pub. No.: US 2024/0326131 A1
(43) Pub. Date: Oct. 3, 2024

(54) MULTI-MATERIAL RECOATER FOR SUPPORT REMOVAL

(71) Applicant: Divergent Technologies, Inc., Los Angeles, CA (US)

(72) Inventors: Michael Thomas KENWORTHY, Rancho Palos Verdes, CA (US); Seyedalireza TORBATISARRAF, Los Angeles, CA (US); Chan Cheong PUN, Costa Mesa, CA (US)

(21) Appl. No.: 18/626,255

(22) Filed: Apr. 3, 2024

Related U.S. Application Data
(60) Provisional application No. 63/493,947, filed on Apr. 3, 2023.

(51) Int. Cl. B22F 10/40; B22F 10/28; B28B 1/00; B29C 64/124; B29C 64/153; B29C 64/209; B29C 64/264; B29C 64/386; B29C 64/40; B33Y 10/00; B33Y 30/00; B33Y 50/00

(52) U.S. Cl. CPC B22F 10/40; B22F 10/28; B28B 1/001; B29C 64/124; B29C 64/153; B29C 64/209; B29C 64/264; B29C 64/386; B29C 64/40; B33Y 10/00; B33Y 30/00; B33Y 50/00

(57) ABSTRACT

A device may deposit a first print material having first material characteristics corresponding to a material strength in a space over a build plate. A device may selectively deposit a second print material having second material characteristics at a print location to modify the material strength at the print location, wherein the print location is at an interface between a first component and a second component.

### CROSS-REFERENCE TO RELATED APPLICATIONS

The present disclosure claims the benefit under 35 U.S.C. 119 of U.S. Provisional Patent Application No. 63/493,947, filed Apr. 3, 2023, and titled “MULTI-MATERIAL RECOATER FOR SUPPORT REMOVAL,” which application is incorporated by reference herein in its entirety.

### BACKGROUND

### Field

The present disclosure relates generally to additively manufactured structures, and more specifically to selectively modifying characteristics at interface locations of additively manufactured structures.

### Description of the Related Technology

Some Additive Manufacturing (AM) processes involve the use of a stored geometrical model for accumulating materials layer by layer on a “build plate” to produce three-dimensional (3-D) objects having features defined by the model. AM techniques are capable of printing complex parts or components using a wide variety of materials. A 3-D printed object is fabricated based on and using a computer-aided design (CAD) model. The AM process can manufacture a solid 3-D object directly from the CAD model using an AM printer without using additional tooling.

One example of an AM process or technique is powder bed fusion (PBF). PBF uses a laser, electron beam, or other energy source to sinter or melt powder that has been deposited in a powder bed. This sintering or melting consolidates powder particles together in targeted areas and, layer by layer, produces a 3-D structure having the desired geometry. Different materials or combinations of materials, such as metals, plastics, and ceramics, may be used in PBF to create the 3-D object. Other AM processes and techniques, including those discussed further below, are also available or under current development, and parts or all of the present disclosure may be applicable to each of these various processes and techniques.

Another example of an AM process is called a Binder Jet (BJ) process. The BJ process uses a powder bed (similar to PBF). Metallic powder is spread in layers in or on the powder bed and the metallic powder is bonded by using an organic binder. The resulting combination of the metallic powder and organic binder is a green part. This green part requires treatment in the form of burning off the organic binder and sintering. The burning and sintering are used to consolidate the treated layers of metallic powder into a full and/or desired density. The metallic powder material can have the same chemical composition and similar physical characteristics as PBF powders in some aspects.

Another example of an AM process or technique is called Directed Energy Deposition (DED). DED is an AM technology that uses a laser, electron beam, plasma, or other energy source. For example, in Tungsten Inert Gas (TIG), or Metal Inert Gas (MIG) welding, the energy source is used to melt the metallic powder, wire, or rod, thereby transforming it into a solid metal object. Unlike many AM technologies, DED is not applied to or on a powder bed. Instead, DED uses either a feed nozzle to propel a powdered metal or a mechanical feed system to deliver a powdered metal or metal wire or rod into a path of the energy source (e.g., laser beam, electron beam, plasma beam, or other energy stream). The powdered metal or the wire or rod are then fused by the respective energy beam. While supports or a freeform substrate may, in some cases, be used to maintain the structure being built, almost all the raw material (metallic powder or metal wire or rod) in DED is transformed into solid metal. Consequently, little waste powder is left to recycle in DED. Using a layer-by-layer strategy, the print head, comprised of the energy beam or stream and the raw material feed system, can scan the substrate to deposit successive layers as related directly from a CAD model.

As discussed above, PBF, BJ, DED, and other AM processes may use various raw materials such as metallic powders, wires, or rods. The raw material may be made from various metallic materials. Metallic materials may include, for example, aluminum, or alloys of aluminum. It may be advantageous to use alloys of aluminum that have properties that improve functionality within AM processes. For example, raw materials for AM processes may be in the form of powdered metals, and particle shape, powder size, packing density, melting point, flowability, stiffness, porosity, surface texture, density, electrostatic charge, as well as other physical and chemical properties may impact how well an aluminum alloy performs in various AM processes. Similarly, raw materials for AM processes can be in the form of a metallic wire or rod whose chemical composition and physical characteristics may impact the performance of the material in various AM processes. Some alloys may include characteristics that impact one or more of the various steps of an AM process and may have traits that affect the suitability and performance of the alloy during and after AM. One or more aspects of the present disclosure may be described in the context of the related technology. None of the aspects described herein are to be construed as an admission of prior art, unless explicitly stated herein.

### SUMMARY

Several aspects of additively manufactured structures, and more specifically to selectively modifying characteristics at interface locations of additively manufactured structures, are described herein.

In some aspects, the techniques described herein relate to a method for producing an additively manufactured (AM) object, including: depositing a first print material having first material characteristics corresponding to a material strength in a space over a build plate; and selectively depositing a second print material having second material characteristics at a print location to modify the material strength at the print location, wherein the print location is at an interface between a first component and a second component.

In some aspects, the techniques described herein relate to a method, wherein the second print material includes an alloy.

In some aspects, the techniques described herein relate to a method, wherein the second print material includes a ceramic.

In some aspects, the techniques described herein relate to a method, wherein the second print material includes a polymer.

In some aspects, the techniques described herein relate to a method, wherein the first component is a wall of the AM object.

In some aspects, the techniques described herein relate to a method, wherein the second component is a structural support of the AM object.

In some aspects, the techniques described herein relate to a method, wherein the second component facilitates access to a region of a completed assembly under special conditions.

In some aspects, the techniques described herein relate to a method, wherein modifying the material strength at the print location includes reducing the material strength at the print location such that the interface between the first component and the second component becomes a separation location under a severability condition.

In some aspects, the techniques described herein relate to a method, wherein the severability condition results from the separation location being more susceptible to chemical etching than the first print material.

In some aspects, the techniques described herein relate to a method, wherein the severability condition results from the separation location being more susceptible to electrochemical etching than the first print material.

In some aspects, the techniques described herein relate to a method, wherein the severability condition results from the separation location being more susceptible to mechanical stress than the first print material.

In some aspects, the techniques described herein relate to a method, wherein the severability condition results from the separation location being more susceptible to both galvanic corrosion and mechanical stress than the first print material.

In some aspects, the techniques described herein relate to a method, wherein depositing the first print material and selectively depositing the second print material are performed concurrently.

In some aspects, the techniques described herein relate to a method, wherein depositing the first print material is performed prior to selectively depositing the second print material.

In some aspects, the techniques described herein relate to a method, wherein selectively depositing the second print material further includes energy deposition.

In some aspects, the techniques described herein relate to a method, wherein selectively depositing the second print material further includes optical manipulation.

In some aspects, the techniques described herein relate to a 3-D printing apparatus for producing an additively manufactured (AM) object, including: a build plate; a depositor operable to deposit a first print material having first material characteristics corresponding to a material strength; and a fabrication modifier operable to selectively deposit one or more secondary materials or selectively modify the first print material; at least one processor; and at least one memory, storing instructions that, when executed by the processor, cause the apparatus to: deposit the first print material via the depositor; and selectively deposit one or more secondary materials or selectively modify the first print material via the fabrication modifier.

In some aspects, the techniques described herein relate to an apparatus, wherein the depositor includes a first hopper containing the first print material and the fabrication modifier includes a container containing the secondary material.

In some aspects, the techniques described herein relate to an apparatus, wherein the container is a second hopper and the secondary material is a powder.

In some aspects, the techniques described herein relate to an apparatus, wherein the container is a cartridge and the secondary material is a liquid.

In some aspects, the techniques described herein relate to an apparatus, further including: a printhead that is selectively movable via a gantry, wherein the printhead is operably coupled with the container containing the secondary material such that the printhead can selectively deposit the secondary material.

In some aspects, the techniques described herein relate to an apparatus, further including: an energy source, wherein selectively depositing the secondary material further includes causing the laser to selectively modify a physical attribute of at least one of the first print material and the secondary material. In some aspects, the techniques described herein relate to a method for producing an additively manufactured (AM) object, including: depositing a first print material having first material characteristics corresponding to a material strength in a space over a build plate; and selectively depositing a second print material having second material characteristics at a print location to modify the material strength at the print location, wherein the print location is at an interface between a first component and a second component.

In some aspects, the techniques described herein relate to a method, wherein the second print material includes an alloy.

In some aspects, the techniques described herein relate to a method, wherein the second print material includes a ceramic.

In some aspects, the techniques described herein relate to a method, wherein the second print material includes a polymer.

In some aspects, the techniques described herein relate to a method, wherein the first component is a wall of the AM object.

In some aspects, the techniques described herein relate to a method, wherein the second component is a structural support of the AM object.

In some aspects, the techniques described herein relate to a method, wherein the second component facilitates access to a region of a completed assembly under special conditions.

In some aspects, the techniques described herein relate to a method, wherein modifying the material strength at the print location includes reducing the material strength at the print location such that the interface between the first component and the second component becomes a separation location under a severability condition.

In some aspects, the techniques described herein relate to a method, wherein the severability condition results from the separation location being more susceptible to chemical etching than the first print material.

In some aspects, the techniques described herein relate to a method, wherein the severability condition results from the separation location being more susceptible to electrochemical etching than the first print material.

In some aspects, the techniques described herein relate to a method, wherein the severability condition results from the separation location being more susceptible to mechanical stress than the first print material.

In some aspects, the techniques described herein relate to a method, wherein the severability condition results from the separation location being more susceptible to both galvanic corrosion and mechanical stress than the first print material.

In some aspects, the techniques described herein relate to a method, wherein depositing the first print material and selectively depositing the second print material are performed concurrently.

In some aspects, the techniques described herein relate to a method, wherein depositing the first print material is performed prior to selectively depositing the second print material.

In some aspects, the techniques described herein relate to a method, wherein selectively depositing the second print material further includes energy deposition.

In some aspects, the techniques described herein relate to a method, wherein selectively depositing the second print material further includes optical manipulation.

In some aspects, the techniques described herein relate to a 3-D printing apparatus for producing an additively manufactured (AM) object, including: a build plate; a depositor operable to deposit a first print material having first material characteristics corresponding to a material strength; and a fabrication modifier operable to selectively deposit one or more secondary materials or selectively modify the first print material; at least one processor; and at least one memory, storing instructions that, when executed by the processor, cause the apparatus to: deposit the first print material via the depositor; and selectively deposit one or more secondary materials or selectively modify the first print material via the fabrication modifier.

In some aspects, the techniques described herein relate to an apparatus, wherein the depositor includes a first hopper containing the first print material and the fabrication modifier includes a container containing the secondary material.

In some aspects, the techniques described herein relate to an apparatus, wherein the container is a second hopper and the secondary material is a powder.

In some aspects, the techniques described herein relate to an apparatus, wherein the container is a cartridge and the secondary material is a liquid.

In some aspects, the techniques described herein relate to an apparatus, further including: a printhead that is selectively movable via a gantry, wherein the printhead is operably coupled with the container containing the secondary material such that the printhead can selectively deposit the secondary material.

In some aspects, the techniques described herein relate to an apparatus, further including: an energy source, wherein selectively depositing the secondary material further includes causing the laser to selectively modify a physical attribute of at least one of the first print material and the secondary material. It will be understood that other aspects of modifying characteristics at interface locations such as interfaces of structures and AM object surfaces and interfaces between AM object components will become readily apparent to those of ordinary skill in the art from the following detailed description, wherein it is shown and described only several embodiments by way of illustration. As will be realized by those of ordinary skill in the art, the manufactured objects, structures, components and interfaces and the methods for manufacturing these objects, structures, components, and interfaces are capable of other and different embodiments, and its several details are capable of modification in various other respects, all without departing from the disclosure. Accordingly, the drawings and detailed description are to be regarded as illustrative in nature and not as restrictive.

### BRIEF DESCRIPTION OF THE DRAWINGS

Various aspects of alloys, ceramics, polymers, and other materials that may be used for additive manufacturing, for example, in automotive, aerospace, and/or other engineering contexts are presented in the detailed description by way of example, and not by way of limitation, in the accompanying drawings, wherein:

FIGS. 1A-1D illustrate respective side views of a 3-D printer system in accordance with an aspect of the present disclosure in accordance with an aspect of the present disclosure;

FIG. 1E illustrates a functional block diagram of a 3-D printer system in accordance with an aspect of the present disclosure in accordance with an aspect of the present disclosure;

FIG. 2 illustrates a build object in accordance with an aspect of the present disclosure in accordance with an aspect of the present disclosure;

FIGS. 3A-3C illustrate a chart of intermetallics, a sample corrosion potential diagram, and effects of intermetallics on mechanical properties chart in accordance with various aspects of the present disclosure;

FIG. 4A shows an illustration of a dual material depositor diagram in accordance with an aspect of the present disclosure;

FIG. 4B shows an illustration of a single material depositor diagram in accordance with an aspect of the present disclosure;

FIG. 4C shows an illustration of a selective layer sintering (SLS) with multi-powder deposition diagram in accordance with an aspect of the present disclosure;

FIG. 4D shows an illustration of a dual material depositor diagram in accordance with an aspect of the present disclosure;

FIG. 5A shows an illustration of a dual material depositor assembly combined with a standard recoater diagram in accordance with an aspect of the present disclosure;

FIG. 5B shows an illustration of a binderjet head mounted on a gantry system diagram.

FIG. 5C shows an illustration of a combined binder jetting and milling system diagram in accordance with an aspect of the present disclosure; and

FIG. 6 illustrates a method of AM in accordance with an aspect of the present disclosure.

### DETAILED DESCRIPTION

The detailed description set forth below in connection with the appended drawings is intended to provide a description of various exemplary embodiments are not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

In various aspects, a recoater can include one or more specialized loader, allowing for one or more different materials to be dosed in accordance with desired spatial locations on a print bed. In some aspects a material selector can be included. The material selector can be used in accordance with or otherwise provide sufficient resolution to precisely match a desired powder with desired coordinates (e.g., x-, y- and/or z-coordinates) so as to accurately position powder particles within or at locations in a given layer during an AM process.

Regarding the powder(s), in various aspects a desirable powder(s) may exhibit one or more particular characteristics that benefit, improve, and/or otherwise effect the AM process in a desirable way. For example, desirable powder(s) can have characteristics such as generally having particles of sufficient density and/or size differences or uniformity so as to be effectively discriminated from other particles by various commonly employed methods. Such methods of discrimination include air classification, which can discriminate according to particle mass, or sieving, which can primarily discriminate based on a size and/or shape of particles. As an example, a powder may include a combination of copper and aluminum. In such powder, a large particle size distribution (PSD) may exist between the copper particles (e.g., from about 80-120 microns) and a smaller PSD may exist between the aluminum particles (e.g., from about 35-75 microns). In this example powder, the largest and heaviest aluminum particle would be about one-third of the mass of the smallest copper particle. Because this particle size difference is discrete, the copper and aluminum particles should be separable, which can be economically advantageous or beneficial through the use of recycling.

When an AM build piece is fabricated using a desirable powder, the materials used in the fabrication may impart one or more useful characteristics on the AM build piece. For example, during AM, supports for a build piece may be fabricated in part or in whole using a desirable powder. These supports may achieve a primary function of efficient heat conduction and mechanical constraint for welding forces as a result of their fabrication using the desirable powder.

As another example, materials in a desirable powder may exhibit a selectivity characteristics to the AM build piece and/or supports. As an example of a selective characteristic, a first material in the desirable powder may impart a characteristic in the AM build piece and/or supports whereby the first material can be selectively acted upon while other material(s) in the desirable powder remain inert or otherwise unaffected. In some instances, this could occur when a particular method renders a target area of the AM build piece vulnerable to one or more of a wide variety of secondary removal processes.

To elaborate, in an example, placement of copper particles could be placed at locations of support structures sufficiently near an AM build piece being printed (i.e., a desired print object), where the AM build piece comprises a corrosion resistant material such as an aluminum alloy. Then, when a secondary removal process is applied to the support structures, the support structures are relatively easily detached, severed, and/or otherwise removed from the AM build piece at designated locations, due to the large density difference of Cu and Al (more than three times difference in density). This type of fabrication can be used to facilitate economically beneficial, useful, and/or necessary separation of constituent powders or materials for further usage as recycled material.

Recycling material can be useful or even ideal, since, after printing, the AM build piece and support structures could be exposed to an event intended to promote accelerated corrosion and weakening of the target area, such as the commonly employed copper accelerated acetic acid salt spray (CASS) test.

In various aspects, other processes and techniques can be used to create “break-away” features such that selective separability between support structures and AM build pieces, between support structures and other support structures, and/or between AM build pieces and other AM build pieces are achieved. Particular combinations of materials that meet desired key characteristics can make this possible in some aspects.

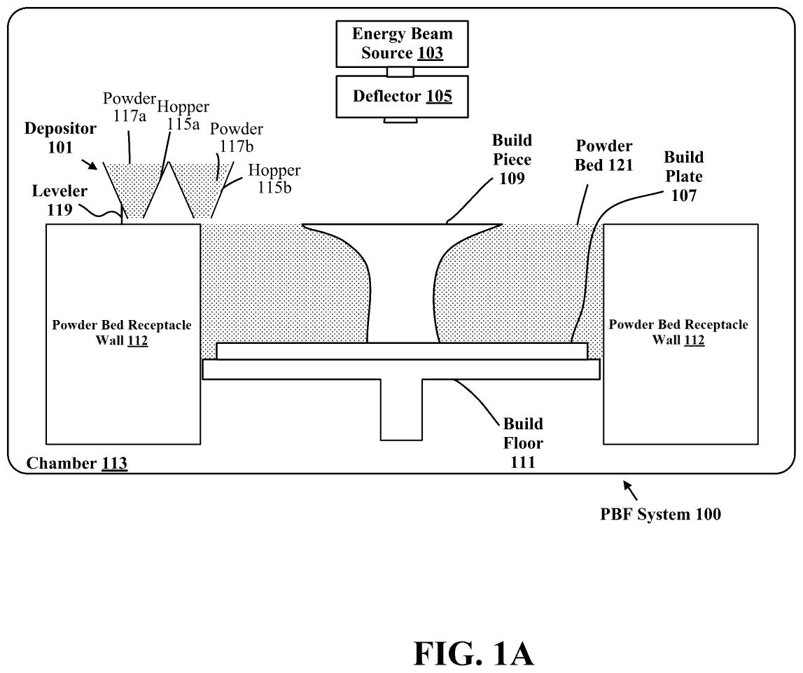

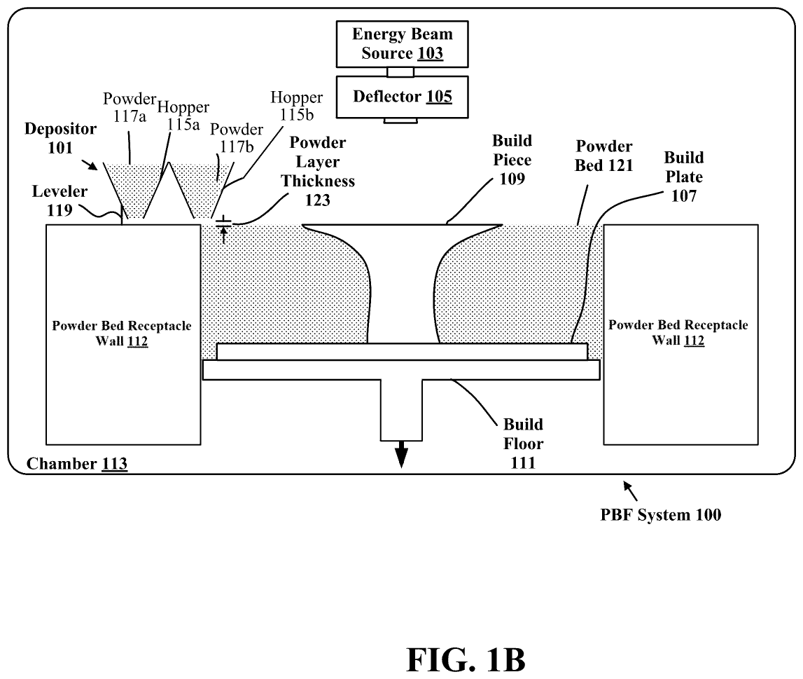

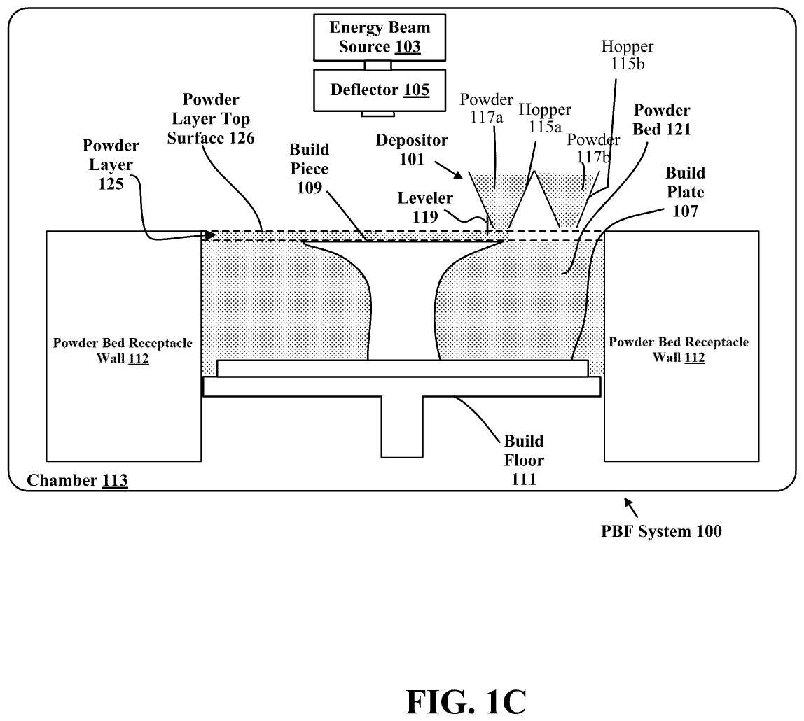

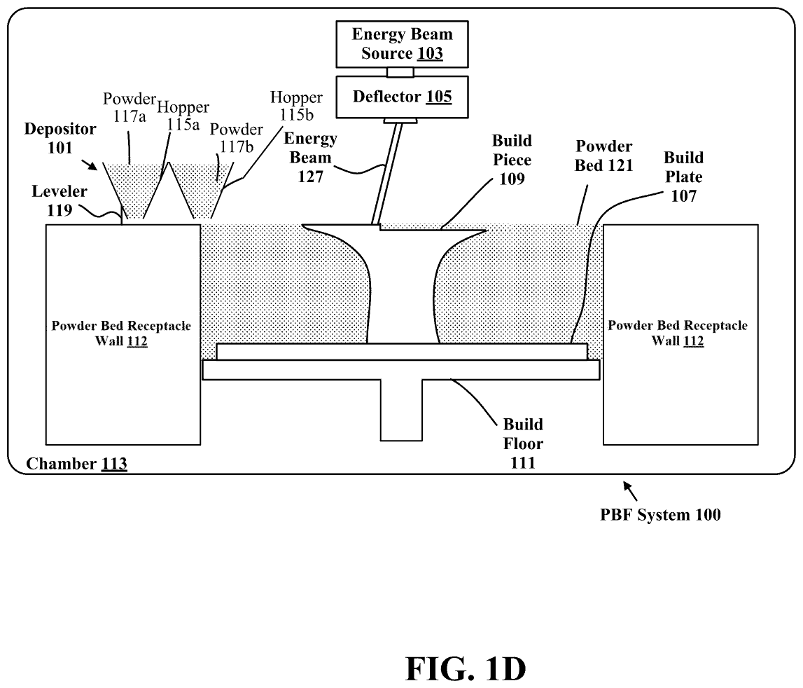

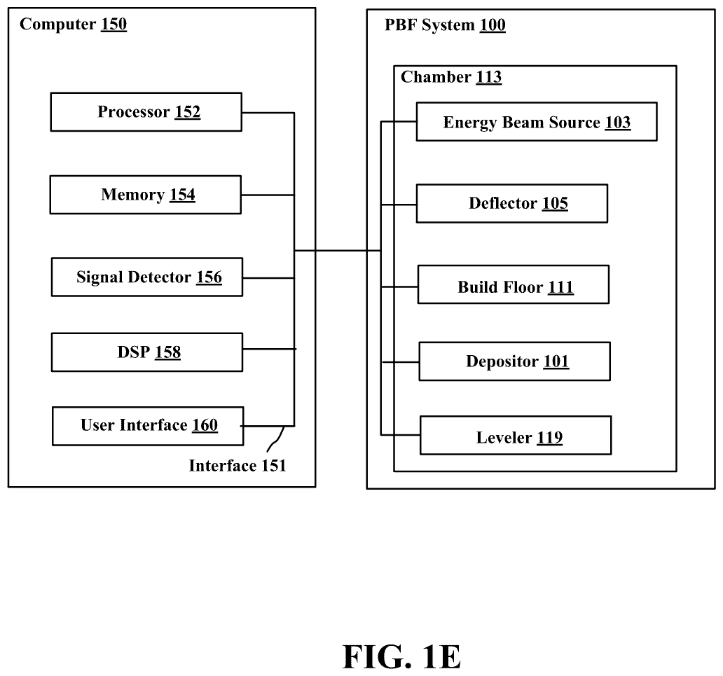

Features promoting, enhancing, achieving, facilitating, or otherwise resulting in selective separability can be used to additively manufacture one or more structures or sub-structures within an AM build piece, component(s), and/or combinations thereof that can be selectively removed at particular points during an AM fabrication process or after an AM fabrication process has been completed. For example, an AM build piece could be a crash rail for a vehicle. In some instances, selective separability or break-away features could be designed and included in a fabrication that are configured to guide energy through or along one or more directed energy paths through the crash rail. Thus, once installed on a vehicle, the crash rail will function as an energy absorption structure, increasing the safety of the vehicle by protecting people or vital components during a crash. As another example, an AM build piece could be a door, panel, latch, or other component, structure, or sub-structure that facilitates access to one or more regions, areas, or locations of an assembled structure under certain conditions. One such condition could be a repair activity condition, whereby the AM build piece could be a removable panel for maintenance of a portion of a vehicle (e.g., a maintenance panel providing access to electrical wiring on the side of a semi-tractor trailer. FIGS. 1A-D illustrate respective side views of an exemplary 3-D printer system for a multi material selective laser sintering build operation.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles providing some of the basis of this disclosure. It should also be noted that elements of FIGS. 1A-D and the other figures in this disclosure are not necessarily drawn to scale but may be drawn larger or smaller for the purpose of better illustration of concepts described herein.

PBF System 100 may be an electron-beam PBF system 100, a laser PBF system 100, or other type of PBF system 100. Further, other types of 3-D printing, such as Directed Energy Deposition, Selective Laser Melting, Binder Jet, etc., may be employed without departing from the scope of the present disclosure.

PBF system 100 can include a depositor 101 that can deposit each layer of powder from multiple powders 117a and/or 117b, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls 112 of the powder bed receptacle generally define the boundaries of the powder bed receptacle, which is located between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation mitigating contamination risks, and allowing for unused powder to be recycled. Depositor 101 can include a first hopper 115a and second hopper 115b. First hopper can contain a first powder 117a, such as a metal powder. Second hopper 115b can contain a second powder 117b, such as a second metal, alloy, or other material. Depositor 101 can also include at least one leveler 119 that can level the top of each layer of deposited powder. Leveler 119 can be located in different locations in different embodiments.

AM processes may produce the build object and may also produce various support structures that maintain structural integrity of the build object during AM processes. Support structures can be nonessential to the build object upon build object completion and may require removal to reduce weight, improve energy distribution, improve aesthetics, or for other beneficial reasons. The particular embodiments illustrated in FIGS. 1A-D are some suitable examples of a dual hopper PBF system employing principles of the present disclosure. Specifically, support structures and interfaces between support structures and build objects that have characteristics that vary from characteristics of the build objects themselves described herein may be used in at least one PBF system 100 described in FIGS. 1A-D. Methods exploiting such support structure and/or interface characteristic differences affecting their removal are also described herein. While one or more methods described in the present disclosure may be suitable for various AM processes (e.g., using a PBF system, as shown in FIGS. 1A-D), it will be appreciated that one or more methods of the present disclosure may be suitable for other applications, as well. For example, one or more methods described herein may be used in other fields or areas of manufacture without departing from the scope of the present disclosure. Accordingly, AM processes employing the one or more methods of the present disclosure are to be regarded as illustrative and are not intended to limit the scope of the present disclosure.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

In various embodiments such powder in powder bed 121 can be beneficially harvested, recaptured, and/or recycled for use in the same or other projects. This can reduce waste, cut costs, and provide other benefits. Systems and methods of such harvesting, recapture, and/or recycling are described herein in further detail, although others are possible based on the characteristics of the materials.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117a and 117b in a space created over the top surfaces of build piece 109 and powder bed 121 and bounded by powder bed receptacle walls 112. In this example, depositor 101 progressively moves over the defined space while releasing powder 117a from hopper 115a and selectively releasing powder 117b from hopper 115b. Leveler 119 can level the released powder to form a powder layer 125 that has a thickness substantially equal to the powder layer thickness 123 (see FIG. 1B) and exposing powder layer top surface 126. Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously deposited layers discussed herein with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with and/or be communicatively coupled with a PBF system 100, and/or other AM systems, via one or more wired and/or wireless interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may store and provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

Processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

Processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117a and/or 117b remaining in depositor 101, location of depositor 101, location of nozzles for hopper 115a and/or 115b, location of pixels and/or voxels, leveler 119 position, and other signals. DSP 158 may be used in processing signals received by the computer 150. The DSP 158 may be configured to generate instructions and/or packets of instructions for transmission to PBF system 100.

The user interface 160 may comprise a speaker, microphone, camera, sensor(s), keypad or keyboard, a pointing device, and/or a display that can be touchscreen in some embodiments. The user interface 160 may include any element or component or combinations thereof that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described herein with respect to the processor 152, but also to implement the functionality described herein with respect to the signal detector 156, the DSP 158, and/or the user interface 160. Further, each of the components illustrated in FIG. 1E may be implemented using a plurality of separate elements.

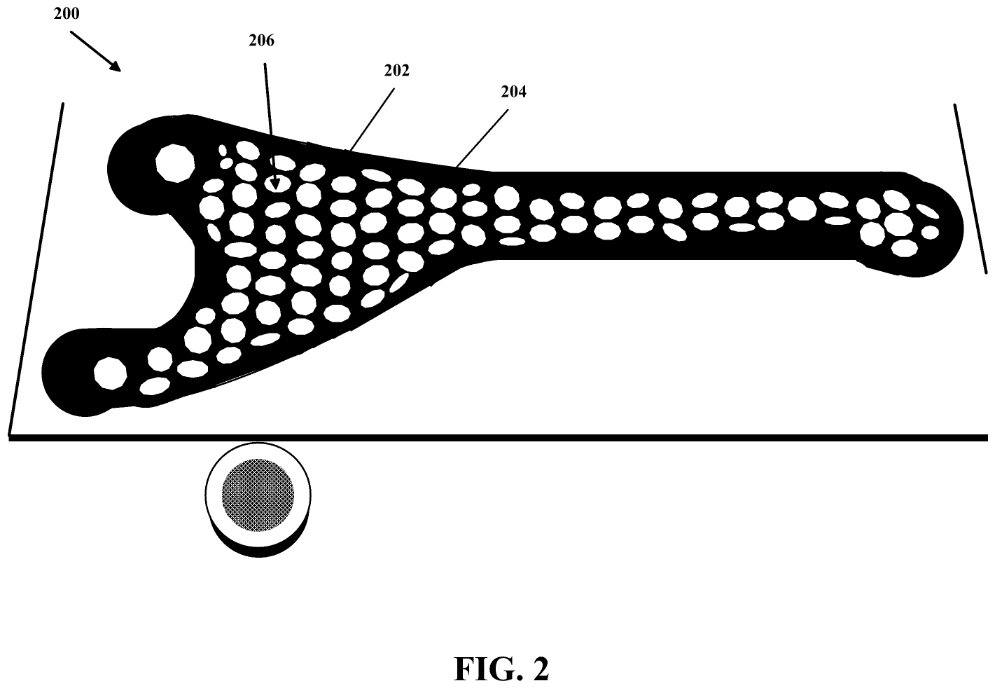

FIG. 2 illustrates a build object 200 in accordance with an aspect of the present disclosure.

3D printing can include the creation of an exterior wall 202 and allows for creation of hollow locations 206 which may have and/or be defined by internal support structures 204 printed inside a hollow portion of exterior wall 202 of the build object 200 to help maintain the part or component shape during the printing process. The use of support structures 204 is applicable 3D printing of organic, metal, hybrid metal/organic, plastic, etc. Once the 3D printing process is completed it may be advantageous to remove the internal and external support structures for weight reduction, or to provide additional flexibility in a printed organic part, for example.

In an aspect of the present disclosure, internal support structures 204 can be removed by breaking or pulverizing the support structures at interface locations where the support structures contact an exterior or interior wall and/or elsewhere through the vibration, movement, chemical or optical treatment, or other methods applied to selectively separable locations of the printed part.

In an aspect of the present disclosure, interfaces and/or other preferred print locations can allow separation or severance of components joined at the interface. In some embodiments a support structures can be a first component joined at an interface with a wall or surface of a build object. In such an aspect, characteristics of the support structure and/or interface can allow for increasing temperatures above a melting point of the support structure and/or interface without exceeding a melt point of a material for the build object. This increase in temperature can facilitate destruction and removal of the support structures from the printed part. The printed part can be subjected to such increased temperatures by direct heating, or introduction of hot gaseous or liquid media into the hollow interior within the printed part, causing softening or melting of the support structures and/or interfaces. The freed or melted support structures can be undergoing additional processes if necessary and can fall away from or out through any opening in the printed part such that they are removed. They can also be removed together with hot gaseous or liquid matter introduced into the hollow structure.

In an aspect of the present disclosure, demolition objects such as solids, liquids, and/or gases can be used and the shape and size of demolition objects can be selected in order to maximize density, enhance break force, and match melt temperature at interface locations, such that the melting temperature of the demolition object is sufficiently below the point at which the printed part might be adversely affected (e.g., melted, softened, etc.), other than at the selectively separable locations such as interfaces between support structures and the AM object. The gas used may be, e.g., an inert gas that can be safely heated to high temperatures. The liquid used may be, e.g., water, or may be an organic or inorganic solution containing salts, or a combination thereof. It may be advantageous to use a gaseous or liquid medium that is not corrosive to the AM object.

In an aspect of the present disclosure, any meltable alloys used at interfaces or as demolition objects can be designed to reduce or minimize toxicity during handling, use, and disposal. For example, and not by way of limitation, cadmium-free alloys may be used. Similarly, liquids or solvents having minimal or reduced toxicity may be preferred, such as water, to reduce exposure to harmful chemicals and disposal concerns.

In an aspect of the present disclosure, shape memory alloy (SMA) materials may be used to allow for the demolition objects to change shape while inside of the printed part or component. SMA materials change shape and/or size upon the application of heat.

### Material Selection

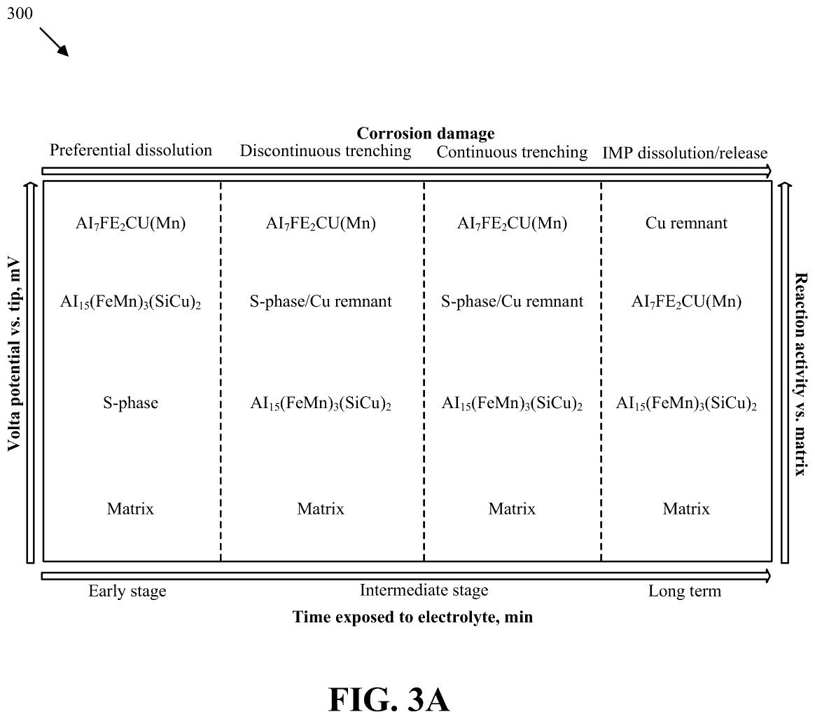

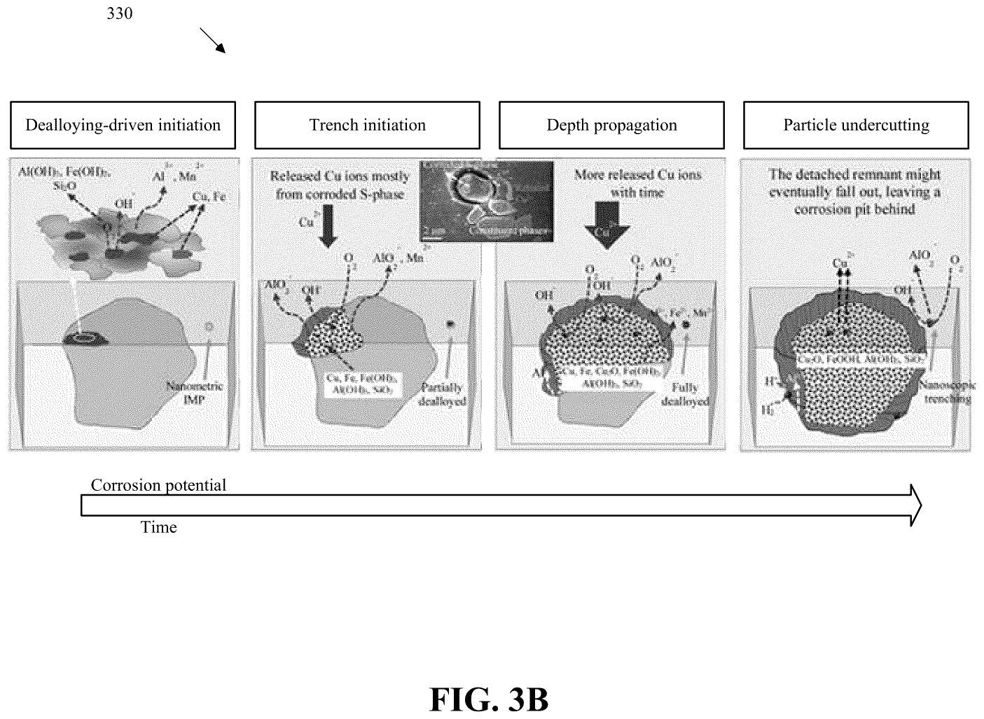

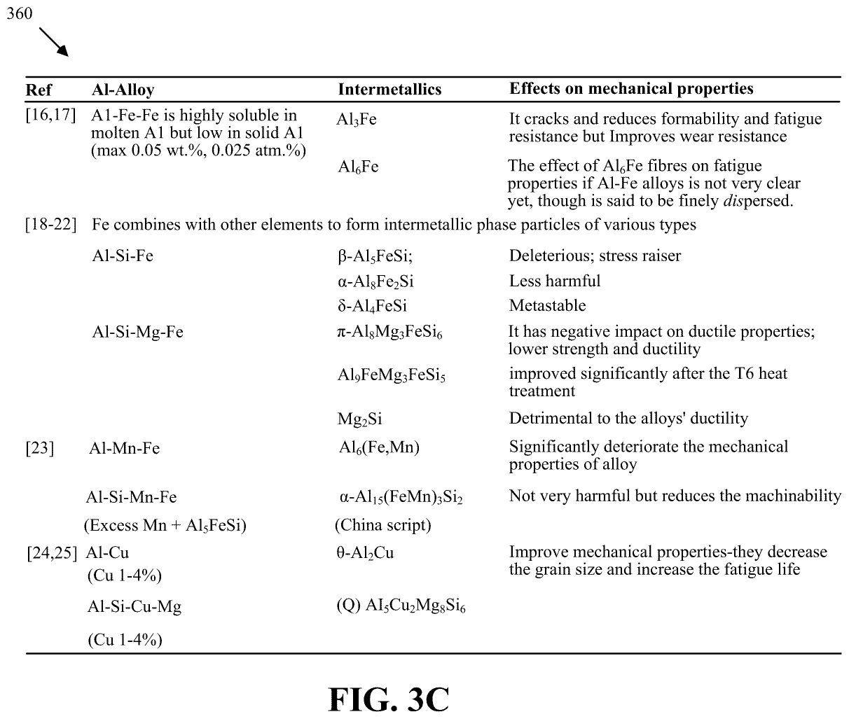

FIGS. 3A-3C illustrate a chart of intermetallics 300, a sample corrosion potential diagram 330, and effects of intermetallics on mechanical properties chart 360 in accordance with various aspects of the present disclosure.

Three main material strategies can be employed when modifying the makeup and/or chemistry of an AM build piece. These three main strategies each selectively add different materials to voxel and/or pixel locations at an interface where modification is desired, such as where selective separability may be employed. In many aspects this can be at selective locations at or near an interface between a support structure and a body structure. Selectively introducing different materials properties (e.g., for deterioration of physical strength to introduce designed selective separability locations). These three main material strategies are 1) Introducing different alloys, 2) Using second phase particles in the form of ceramics and making Meta Matrix Composites, and 3) Alloy poisoning, wherein polymer is infused into powder and thereby degrades properties by in situ introducing carbon-based ingredients (i.e., poisoning the alloy). These modifications to material chemistries can be pre-made and deposited concurrently or doped with one or more additional apparatus at desired locations for selective separability after recoating has occurred.

Several example instances follow. Each of these instances implements the above-described concept of add different materials to voxel and/or pixel locations at an interface where modification is desired.

### Option 1: Introducing Intermetallics (IMCs) to a Material

Generally, introduction of IMCs to a material can include three concepts.

1. A first concept includes an example structure can be selectively destabilized at selective separability locations by chemically modifying connection and/or interface points. In some aspects, these connection and/or interface points can exist or be created between one or more support structures and an AM build piece. This includes promoting preferential corrosion at selective separability locations through galvanic connection at an interface or junction by two or more material constituents. Some aspects include doping to create differentiated chemistry and chemically and/or electrochemically etching away the selective separability location (e.g., junction) after the AM fabrication process is complete. This solution may be achieved with similar alloys by increasing an alloying element content, such that the amount of the alloying element is exaggerated at the junction, as compared to elsewhere in the AM build piece, to generate selectively different chemistry. Various different materials can provide selectively separable weakness with IMCs. One or more of Iron (Fe), Copper (Cu), Manganese (Mn), and Silicon (Si) can be used in various aspects.

As shown in FIG. 3A, a chart of intermetallics 300 can include Volta potential vs. tip mV and reaction activity vs. matrix are shown as increasing on the vertical axis from bottom to top, while corrosion damage and time exposed to electrolyte in minutes are shown as increasing along the horizontal axis from left to right.

2. A second weakening concept can include an example structure that can be mechanically weakened by introducing materials such as Iron, or by introducing a combination of two or more elements such as Iron and Silicon or Iron and Manganese to generate deleterious type phases. Elements used can be those that make metastable and or incoherent type IMCs within a base material and decrease the fracture toughness (i.e., ability to withstand fractures) by more than double versus a non-weakened structure. The Iron or other type of alloying elements that make such IMCs therefore reduce the fracture toughness of material. Iron (Fe), Copper (Cu), Manganese (Mn), Magnesium (Mg), and Strontium (Sr) are good elements for various deleterious type phases and can be used, for example in an Aluminum, Silicon, and X element combination, where they replace the X element.

As shown in FIG. 3B, a sample corrosion potential diagram 330 can include a number of states or phases. These states or phases can correspond to increasing corrosion potential with respect to time as shown at the bottom of the diagram by the arrow from left to right. A first state or phase can include a dealloying-driven initiation. A second state or phase can include a trench initiation. A third state or phase can include a depth propagation. A fourth state or phase can include particle undercutting.

3. A third weakening concept is a hybrid or combination of the destabilization and mechanical weakening presented above. For example, a second material can be additively manufactured that introduces both deleterious properties and galvanic corrosion to base aluminum alloys. In this example, a preferential etch removal of the IMC from an exterior location can be performed to generate a plurality of pits or other weakened locations. This ultimately results in the generation of a mechanically weakened interface that relatively minor stresses (as compared with stresses required to break an unaltered material) can break away. An example of minor stress introduction includes a tumbler that effects vibratory energy on the mechanically weakened interface. Alternatively or additionally, for IMCs that are mechanically weak, vibration may introduce cracks and corrosive media can promote crack lengthening and ultimately result in detachment of the support. In these examples mechanical stresses required for post process selective severability is significantly reduced by combination presented in the third weakening concept.

As shown in FIG. 3C, effects of intermetallics on mechanical properties chart 360 illustrates a variety of effects based on different types of intermetallics. These can range in scope from cracking and reducing formability and fatigue resistance but improving wear resistance, deleterious stress raiser, negative impact on ductile properties with lower strength and durability, and various others.

Option 2: Doping Using Ceramics and/or Metal Matrix Composites (MMCs)

In a second option, an addition of a nontrivial or exaggerated quantity of ceramics (i.e., a completely incoherent phase as compared to the different alloy compositions in option 1 above) can include a base alloy that is then doped with ceramics. MMC structures such as Aluminum (e.g., a base alloy) and an additional percentage (e.g., 60-95%) of Aluminum oxide (Al2O3) can also address all three concepts. In this example, a second phase may remain unmodified and after AM fabrication may result in a structure seeded defect at a selective separation location such as an interface. An aluminum matrix can virtually guarantee heat conductivity of the MMC voxel from melt pool to the build plate.

### Option 3: Doped Polymer

In a third option, additional carbon polymers can introduce inherent weakness at a selectively separable interface location of a structure by introducing a required quantity of brittle carbides and gas pores at the same time or at nearly the same time.

A binder can be coated on top of a second phase powder and added the powder via a concurrent dual recoater. Alternatively, the binder can be added directly via one or more ink or binder jet AM print head to a layer after a powder dispensing system dispenses original and/or base material.

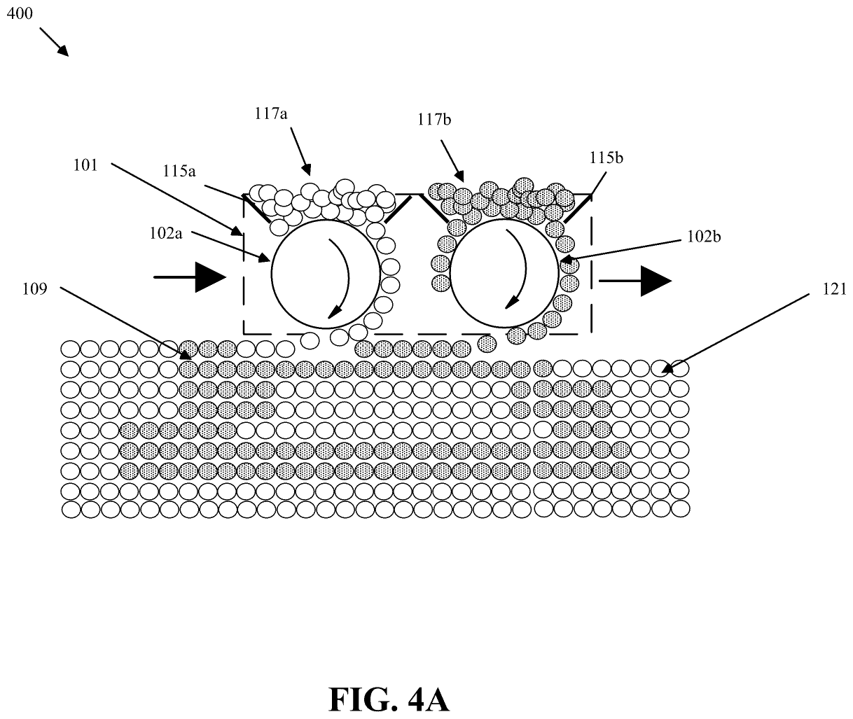

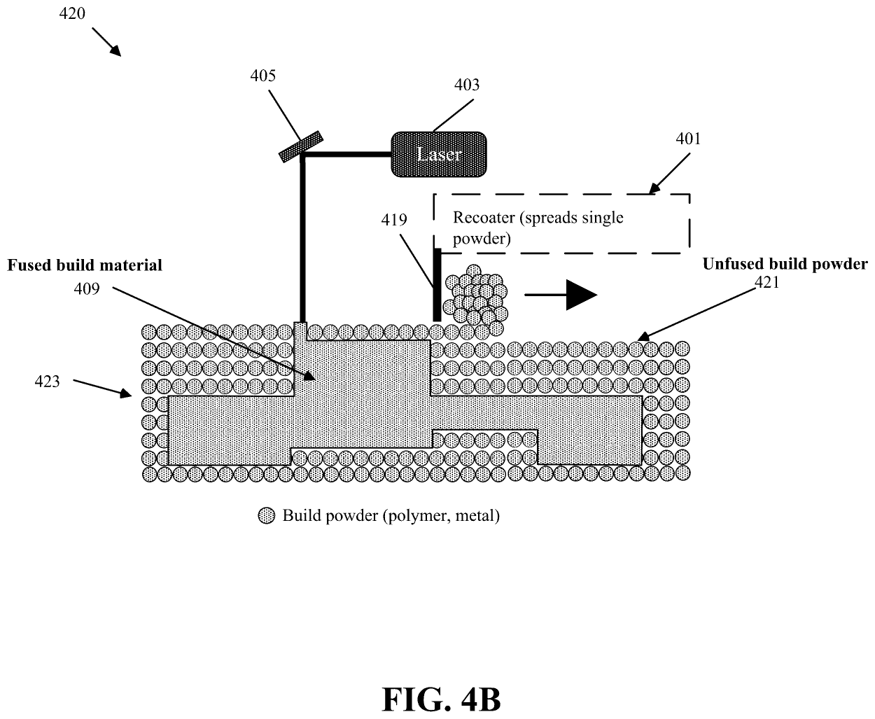

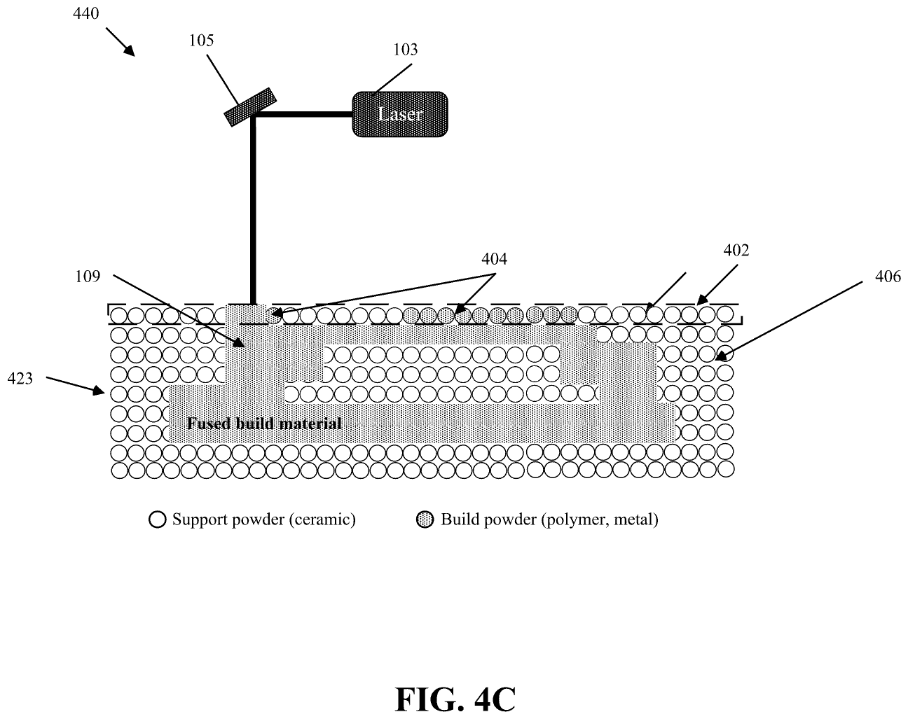

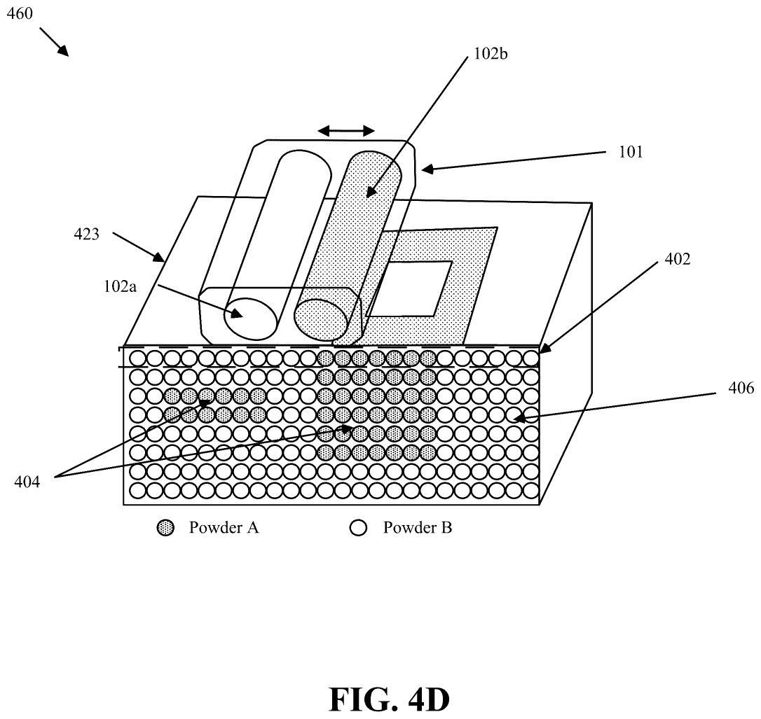

FIGS. 4A-4D illustrate examples of various aspects of multi-material apparatuses.

One such apparatus can be a dual dispenser concurrent deposition (DDCD) apparatus.

A DDCD apparatus can include a dual recoater that is operable to perform additive manufacturing according to one or more programs, whereby pixels or voxels are filled with different materials.

FIG. 4A shows an illustration of a dual material depositor diagram 400. As shown in diagram 400, at a stage in which a depositor 101 is positioned to deposit powder 117a and 117b in a space created over the top surfaces of build piece 109 and powder bed 121. In this example, depositor 101 includes a depositing mechanism such as cylindrical drums 102a, 102b and as the depositor progressively moves over the defined space while releasing powder 117a from hopper 115a and selectively releasing powder 117b from hopper 115b. Depositing mechanisms can be nozzles or other mechanisms in various embodiments.

FIG. 4B shows an illustration of a single material depositor diagram 420. As shown in diagram 420, at a stage in which a depositor 401 is positioned to deposit powder 421 in a space created over powder bed 423, including fused build material 409 and unfused build material 421. In this example, depositor 401 includes a depositing mechanism (not shown) and as the depositor progressively moves over the defined space while releasing powder 421 from a hopper (not shown). Depositing mechanisms can be nozzles or other mechanisms in various embodiments. An energy source 403 such as a laser can be selectively applied via a deflector 405 to particular locations of unfused build powder 421 in order to effect a change in the powder and fuse selective locations of the powder with the fused build material 409 to form the AM build piece.

FIG. 4C shows an illustration of a selective layer sintering (SLS) with multi-powder deposition diagram 440. As shown in FIG. 4C, a build layer 402 at the top of a powder bed 423 can include support powder 406 (e.g., a ceramic powder) and build powder 404 (e.g., including one or more of polymer, metal, or others). As an energy source 103 such as a laser is directed at selected build pixels, voxels, areas, or locations of build layer 402, it can fuse build powder 404 with fused build material that makes up a build piece 109 and thereby form an AM build piece layer by layer. Support powder 406 remains untreated and does not fuse with build piece 109.

FIG. 4D shows an illustration of a dual material depositor diagram 460. As shown in diagram 460, at a stage in which a depositor 101 is positioned to deposit powder 117a and 117b in a top layer 402 of powder bed 423. In this example, depositor 101 includes a depositing mechanism such as cylindrical drums 102a, 102b and as the depositor progressively moves over the defined space while releasing powder 404 from a hopper (not shown) and selectively releasing powder 406 from a second hopper (not shown). Depositing mechanisms can be nozzles or other mechanisms in various embodiments. A number of layers may be created and may be iteratively treated to fuse build materials at particular times or locations.

### Post Recoater Doping

One or more aspects herein can include the use of a standard recoater. This standard recoater can be upgraded by coupling or otherwise adding an apparatus to the recoater such that the apparatus is located on the recoater. Alternatively, an apparatus can be added or located separate from the original recoater, such as on a gantry system with one or more additional AM print head(s) that are operable to deposit secondary materials into, on, or among an original or base layer of a deposited base material at intended locations. For post recoater doping, it may not be necessary to replace a recoater. Instead, an additional apparatus on the top or otherwise above a standard recoater can convert the standard recoater to a dual technology recoater. Doping specific areas, such as particular pixels on a per layer basis, with alloying elements in the form of ink, binders, or in a coherent phase (e.g., ceramic phase(s)) are possible.

A recoater can also be upgraded to a specialized loader, where a second material can be dosed in accordance with particular spatial locations on the print bed is also possible. One or more material selector(s) with sufficient resolution to precisely match a desired powder material to coordinates (e.g., x-, y-, z-coordinates) within a given layer.

For example, an apparatus could deposit Aluminum as a base material via a traditional recoater, while a secondary material such as a polymer media could be dropped as a carbon-based material from an apparatus arrangement on back end of the traditional recoater and/or independently via a gantry system. This binder polymer can be used to turn a carbon element into a desired composition during a lasing step performed on specific selected areas, locations, pixels, and/or voxels. Chemistry changed during melting or lasing of support interface pixels can occur through “in situ alloying.” A remnant of the agglomerated particles through the binder can be sieved before powder is reused. This can remove contamination and result in recycled powder.

In another example, after energy deposition of a final layer of material that forms support structures for an AM build piece, a dissimilar material can be deposited via an aerosol method (e.g., by depositing from an additional dispensing function on the recoater blade) to form a layer (e.g., about 300 micrometers) that can be broken off with case after sintering is complete. For instance, Al2O3 aerosol and Al2O3 paint are known substances used in binderjet additive manufacturing processes to separate steel part versus support structures and setters. Depending on a solidus temperature of the base material (e.g., metal), aerosol material compositions can be matched (e.g., Alloy 5250/Al2O3 spray, Ti-6Al-4V/Y2O3 spray, or others). In some aspects, Al2O3 spray can be desirable due to its ability to perform well with all non-refractory metal.

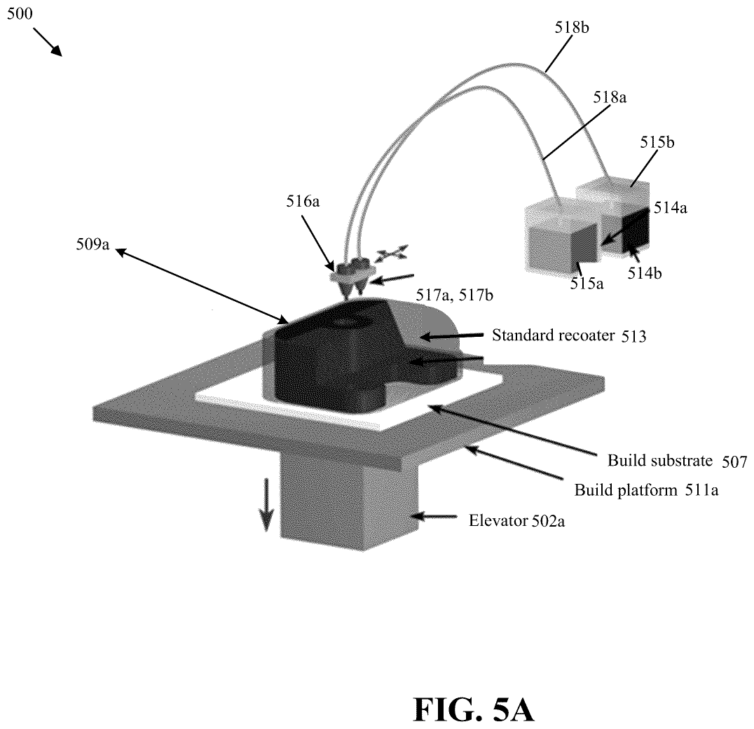

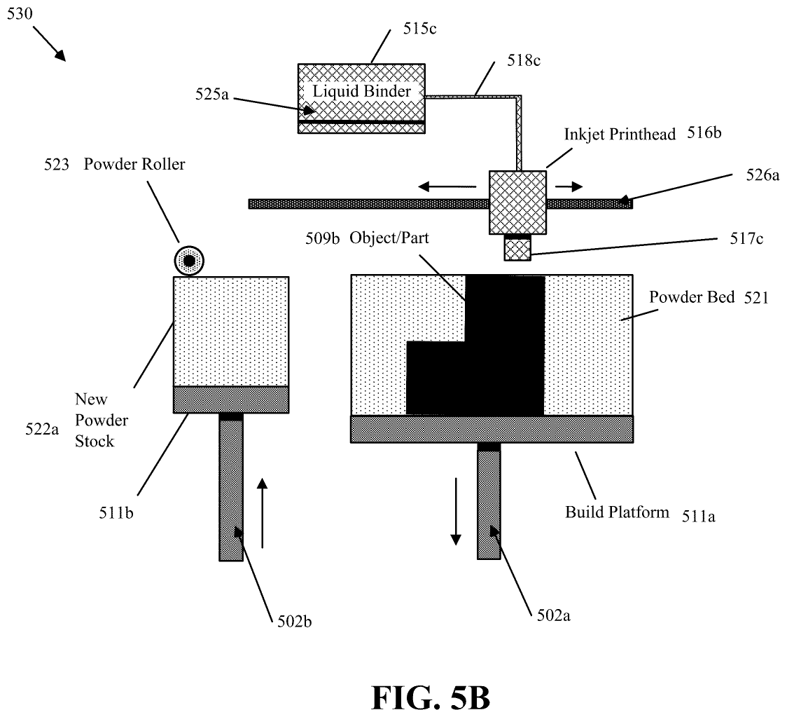

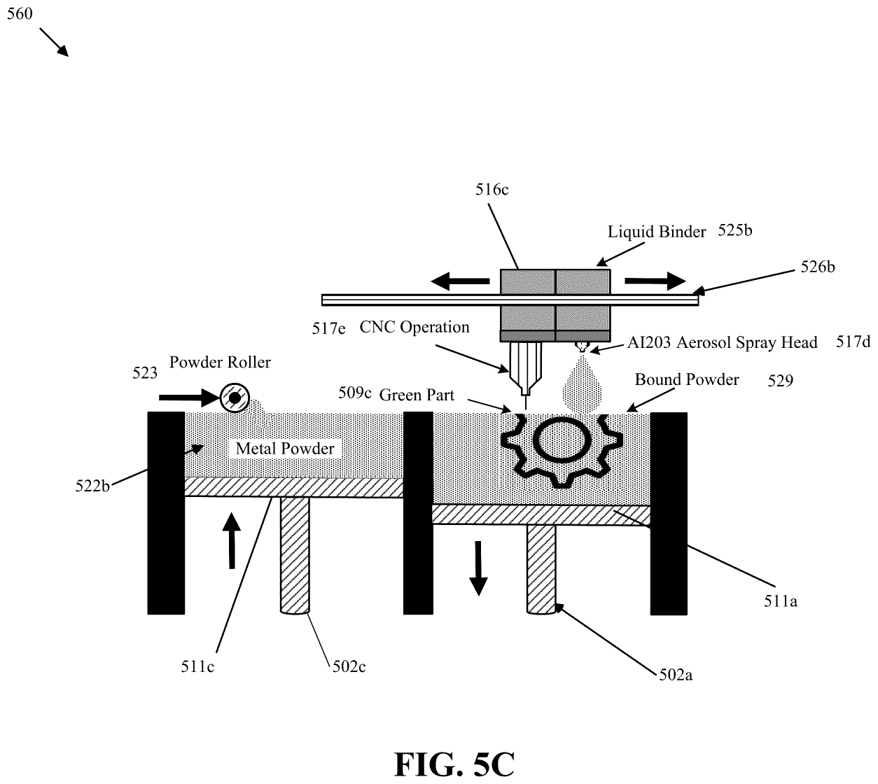

FIGS. 5A-5C illustrate examples of various aspects of multi-material apparatuses.

FIG. 5A shows an illustration of a dual material depositor assembly combined with a standard recoater diagram 500. As shown in diagram 500, a standard recoater 513 can apply consistent, even layers of powdered material on a build substrate 507 that is positioned on a build platform 511a coupled or integrated with a build platform elevator 502a. One or more second phase inks (e.g., inks 514a, 514b) can be stored in one or more cartridges 515a, 515b. Second phase inks 514a, 514b can be sprayed, dripped, or otherwise deposited at desired locations via a print head 516a that includes one or more inkjet heads 517a, 517b including appropriate mechanisms such as nozzles, stoppers, or others. Inkjet heads 517a, 517b are in fluid communication with cartridges 515a, 515b via one or more hoses 518a, 518b. Print head 516a can be coupled or otherwise mounted on a gantry system (not shown) such that it can move in one, two, or three dimensions. In some embodiments, print head 516a can rotate and deposit ink from one or more angles relative to horizontal and/or vertical planes. Object 509a can be formed in the powder bed when liquid binder second phase inks 514a, 514b are selectively applied to one or more layers of powder in the powder bed at appropriate locations.

FIG. 5B shows an illustration of a binderjet head mounted on a gantry system diagram 530. As shown in diagram 530, new powder stock 522a resting on a stock platform 511b can be elevated by elevator 502b that is coupled to, integrated with, or otherwise supporting stock platform 511b. Once located and/or positioned at a particular and/or appropriate elevation, new powder stock 522a can be pushed and/or otherwise moved (generally horizontally) by a powder roller 523, layer by layer, to a powder bed 521. In powder bed 521, powder rests on a build platform 511a that can be lowered by a build platform elevator 502a that is coupled to, integrated with, or otherwise supporting build platform 511a. One or more liquid binders 525a can be stored in one or more liquid binder tanks 515c. Liquid binder 525a can travel through a hose 518c to an inkjet printhead 516b, where it can be sprayed, dripped, or otherwise deposited at desired locations via one or more inkjet heads 517c that is coupled with or integrated into inkjet printhead 516b and which includes appropriate mechanisms such as nozzles, stoppers, or others. Inkjet printhead 516b is in fluid communication with liquid binder tank 515c via one or more hoses 518c. Inkjet printhead 516b can be coupled or otherwise mounted on a gantry system 526a such that it can move in one, two, or three dimensions. In some embodiments, inkjet printhead 516b can rotate and deposit ink from one or more angles relative to horizontal and/or vertical planes. Object 509b can be formed in powder bed 521 when liquid binder 525a is selectively applied to one or more layers of powder in powder bed 521 at appropriate locations. FIG. 5C shows an illustration of a combined binder jetting and milling system diagram 560. As shown in diagram 530, metal powder stock 522b resting on a stock platform 511c can be elevated by elevator 502c that is coupled to, integrated with, or otherwise supporting stock platform 511c. Once located and/or positioned at a particular and/or appropriate elevation, metal powder stock 522b can be pushed and/or otherwise moved (generally horizontally) by a powder roller 523, layer by layer, to a powder bed 521. In powder bed 521, powder rests on a build platform 511a that can be lowered by a build platform elevator 502a that is coupled to, integrated with, or otherwise supporting build platform 511a. One or more liquid binders 525b can be stored in one or more liquid binder tanks, which can be part of a binder printhead 516c. Binder printhead 516c can spray, drip, or otherwise deposit liquid binder 525b at desired locations via one or more spray heads that is coupled with or integrated into binder printhead 516c and which includes appropriate mechanisms such as nozzles, stoppers, or others. In the example, liquid binder 525b can be deposited via aerosol spray by aerosol spray head 517d. Binder printhead 516c can be coupled or otherwise mounted on a gantry system 526b such that it can move in one, two, or three dimensions. In some embodiments, binder printhead 516c can rotate and deposit ink from one or more angles relative to horizontal and/or vertical planes. Object 509c can be formed in bound powder 529 when liquid binder 525b is selectively applied to one or more layers of powder at appropriate locations. CNC operation mechanism 517e can perform CNC operations as appropriate.

### 3. Optical Manipulation

Producing seeded defects through laser beam shaping within the vicinity or at particular locations of an AM build piece and/or part inside a support structure at an interface can be achieved via optical manipulation. For example, this can include programmable beam shaping to modulate a laser spot size projected on or at specific pixels and/or voxels. An enlarged shape and configuration can provide on-the-fly switching on a laser, enabling the melting of secondary materials on or at intended pixels. This can help to produce selectively separable, structurally weakened interfaces and/or locations of the AM build piece and/or support structure on the intended pixels or voxels at the interface of the AM build piece and associated support structure. In some aspects, this concept can be accomplished without using second phase chemistry. Optical manipulation can also be also useful when using large particle size distribution (PSD) for the support structure. For example, large beam shapes can address the usage of large PSD for secondary material(s). Separation of materials can be relatively easy using optical manipulation techniques, by simply sieving larger powders sizes and recycling the powder for re-use.

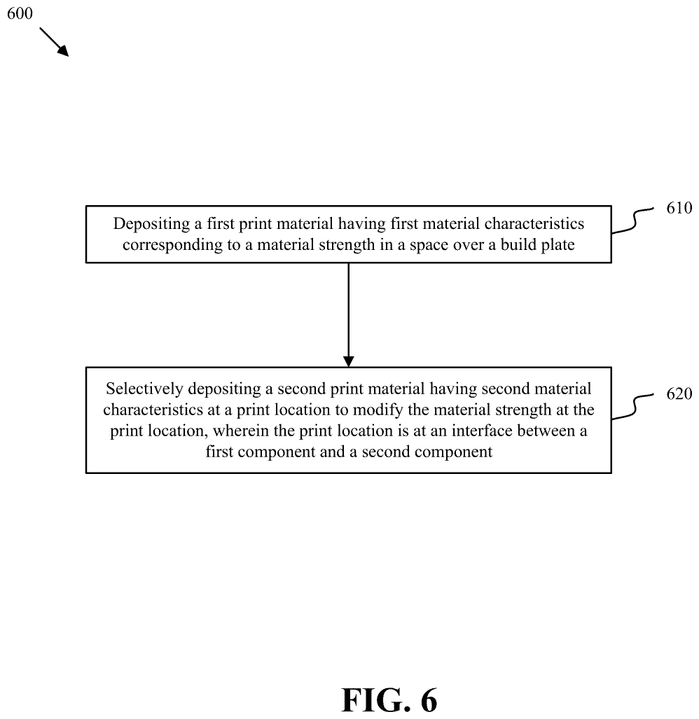

FIG. 6 is a flowchart of an example method for producing an additively manufactured (AM) object.

At step 610, an AM method can include depositing a first print material having first material characteristics corresponding to a material strength in a space over a build plate.

At step 620, an AM method can selectively deposit a second print material having second material characteristics at a print location to modify the material strength at the print location, wherein the print location is at an interface between a first component and a second component.

The previous description is provided to enable any person ordinarily skilled in the art to practice the various aspects described herein. Various modifications to these exemplary embodiments presented throughout this disclosure will be readily apparent to those of ordinary skill in the art, and the concepts disclosed herein may be applied to aluminum alloys. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), or analogous law in applicable jurisdictions, unless the element is expressly recited using the phrase “means for” or, in the case of a method claim, the element is recited using the phrase “step for.”

What is claimed is:

1. A method for producing an additively manufactured (AM) object, comprising:
depositing a first print material having first material characteristics corresponding to a material strength in a space over a build plate; and
selectively depositing a second print material having second material characteristics at a print location to modify the material strength at the print location,
wherein the print location is at an interface between a first component and a second component.

2. The method of claim 1, wherein the second print material comprises an alloy.

3. The method of claim 1, wherein the second print material comprises a ceramic.

4. The method of claim 1, wherein the second print material comprises a polymer.

5. The method of claim 1, wherein the first component is a wall of the AM object.

6. The method of claim 1, wherein the second component is a structural support of the AM object.

7. The method of claim 1, wherein the second component facilitates access to a region of a completed assembly under special conditions.

8. The method of claim 1, wherein modifying the material strength at the print location comprises reducing the material strength at the print location such that the interface between the first component and the second component becomes a separation location under a severability condition.

9. The method of claim 8, wherein the severability condition results from the separation location being more susceptible to chemical etching than the first print material.

10. The method of claim 8, wherein the severability condition results from the separation location being more susceptible to electrochemical etching than the first print material.

11. The method of claim 8, wherein the severability condition results from the separation location being more susceptible to mechanical stress than the first print material.

12. The method of claim 8, wherein the severability condition results from the separation location being more susceptible to both galvanic corrosion and mechanical stress than the first print material.

13. The method of claim 1, wherein depositing the first print material and selectively depositing the second print material are performed concurrently.

14. The method of claim 1, wherein depositing the first print material is performed prior to selectively depositing the second print material.

15. The method of claim 14, wherein selectively depositing the second print material further comprises energy deposition.

16. The method of claim 1, wherein selectively depositing the second print material further comprises optical manipulation.

17. A 3-D printing apparatus for producing an additively manufactured (AM) object, comprising:
a build plate;
a depositor operable to deposit a first print material having first material characteristics corresponding to a material strength;
a fabrication modifier operable to selectively deposit one or more secondary materials or selectively modify the first print material;
at least one processor; and
at least one memory, storing instructions that, when executed by the processor, cause the apparatus to:
deposit the first print material via the depositor; and
selectively deposit one or more secondary materials or selectively modify the first print material via the fabrication modifier.

18. The apparatus of claim 17, wherein the depositor comprises a first hopper containing the first print material and the fabrication modifier comprises a container containing the secondary material.

19. The apparatus of claim 18, wherein the container is a second hopper and the secondary material is a powder.

20. The apparatus of claim 18, wherein the container is a cartridge and the secondary material is a liquid.

21. The apparatus of claim 18, further comprising:
a printhead that is selectively movable via a gantry,
wherein the printhead is operably coupled with the container containing the secondary material such that the printhead can selectively deposit the secondary material.

22. The apparatus of claim 17, further comprising:
an energy source,
wherein selectively depositing the secondary material further comprises causing the energy source to selectively modify a physical attribute of at least one of the first print material and the secondary material.
